(19) United States
(12) Patent Application Publication
(10) Pub. No.: US 2011/0218867 A1
(43) Pub. Date: Sep. 8, 2011

(54) SYSTEM, METHOD, AND COMPUTER PROGRAM PRODUCT FOR FURTHER COMPUTER INTEGRATION IN THE FOOD SERVICE INDUSTRY

(76) Inventor: Joseph A. Cerrato, Longview, TX (US)

(21) Appl. No.: 13/039,182

(22) Filed: Mar. 2, 2011

Related U.S. Application Data
(60) Provisional application No. 61/309,508, filed on Mar. 2, 2010.

(51) Int. Cl. G06Q 50/00

(52) U.S. Cl. 705/15

(57) ABSTRACT

A system, method, and computer program product are provided for integrating a computer network in a restaurant. In operation, user-defined information is input into the system via a customer computer. Additionally, user-defined information is input into the system via staff computers. Furthermore, information becomes readily available for display on staff computers, while limited information is made available to customer computers.

### BACKGROUND AND FIELD OF THE INVENTION

The present design is a progressive approach to further computerizing service industries and presents particular interest towards restaurants.

### SUMMARY

A system, method, and computer program product are provided for integrating a computer network in a restaurant. In operation, user-defined information is input into the system via a customer computer. Additionally, user-defined information is input into the system via staff computers. Furthermore, information becomes readily available for display on staff computers, while limited information is made available to customer computers.

### BRIEF DESCRIPTION OF THE DRAWINGS

FIG. 1 illustrates a network architecture, in accordance with one embodiment.

FIG. 2 illustrates an exemplary computer system in which the various embodiments and/or functionality of the architecture may be implemented.

FIG. 3 shows an exemplary method in which the food service process would be carried through in its entirety.

### DETAILED DESCRIPTION

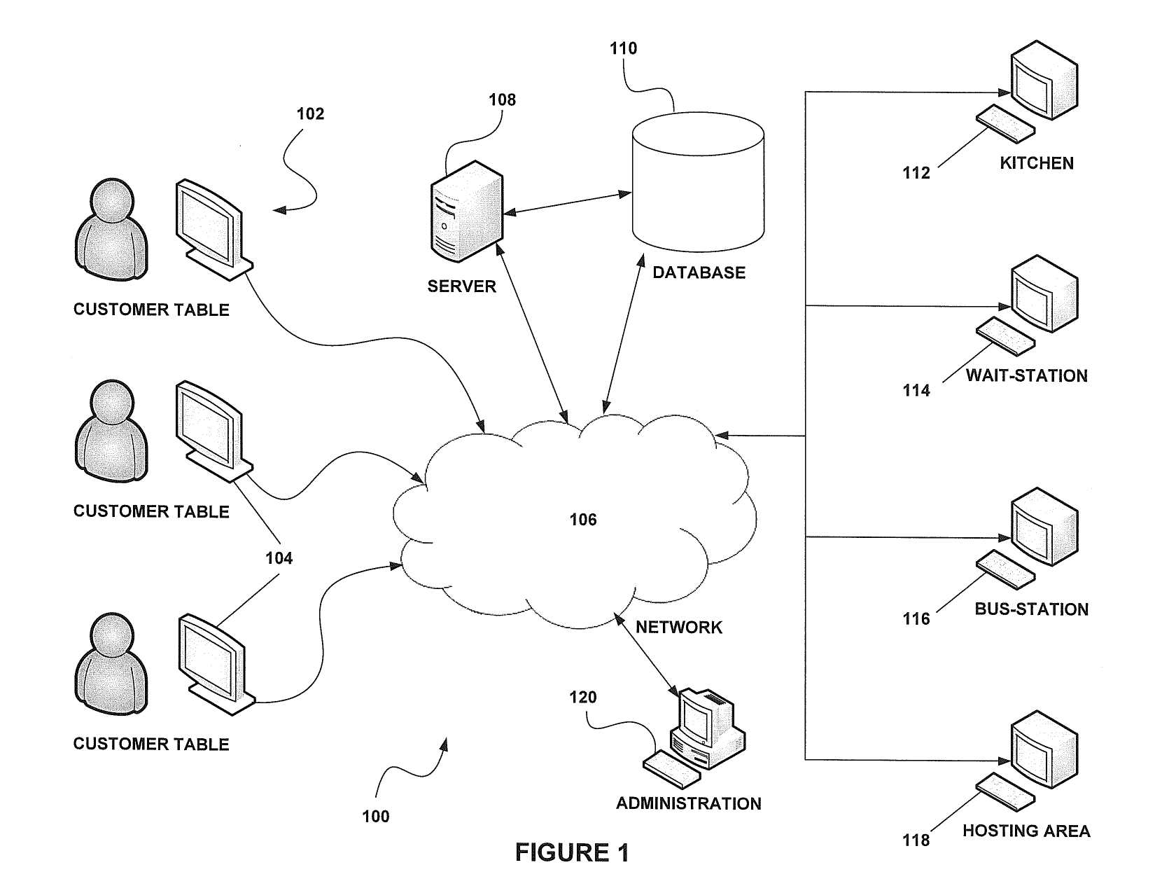

FIG. 1 illustrates a network architecture 100, in accordance with one embodiment. At least one network is provided in the form of a local area network (LAN) or wide area network (WAN). While only one network is shown, it should be understood that two or more similar or different networks may provided.

As shown, a first device 102 is in communication with one or more networks 106. The first device 102, though identical to other initiating devices 104, is not in communication with other initiating devices 104, though the devices share a network 106.

The first device 102 and other initiating devices 104 may also be in communication with one or more network servers 108. The server 108 may be capable of providing the devices with applications, special offers, help features, and various other information. A database 110 may also be accessible by the initiating devices 104 and the server 108. The database 110 may store a plurality of images, menu information, prices, table orders, various workstations 112, 114, 116, 118 statuses, and other information.

The server 108 may also provide the various workstations 112, 114, 116, 118 with notifications and other forms of information related to all user-operated devices 104, 112, 114, 116, 118, 120 on the network 106 including, but not limited to, customer food orders, food preparation status, table availability, customer special requests, table cleanliness, etc.

The first device 102 may be used by the customer to place an order via keyboard input or touch-screen technology. The orders may include, but are not limited to any particular notes (e.g. food allergies, quantities of condiments and/or other foods, etc.), and tab-splitting features. The devices 102 may or may not include a credit/debit card swipe, on-screen check signature capabilities, monetary insertion slots, change dispensers, receipt printer, etc. in its apparatus.

The other initiating devices 104 carry the same designs and implications as 102 but may not exchange information between the two devices. Likewise, device 102 shares the same designs and implications as 104.

The server 108 may be capable of a plurality of functions. The following should be noted as exemplary operation features and not construed as limitations to the extent of the design.

The server 108 may provide devices 104 with the menu applications, any information regarding special offers or updates, an option to request assistance from a waiter or manager, and names of their current waiter and/or manager and/or chef. Additionally, the server 108 may provide the devices 104 with previously mentioned electronic payment features. Furthermore, an estimated time of arrival of ordered food may be delivered to the device 104 by the kitchen staff at computer terminal 112 through the network 106.

The server 108 may provide the kitchen device 112 with displayed information regarding customer order status and details, tables occupied and times of customer arrival/departure, resources available (regarding both food items and personnel), automatic tracking of food expenditures, etc. The kitchen staff may use the device 112 to update the wait-station staff terminal 114 and the customer device 104 of food preparation status. The kitchen staff terminal 112 may be equipped with touch-screen technology. As an example, the screen may display all the tables in the restaurant. A member of the kitchen staff may then touch a table, and the screen will then display, via pop-up window or any other type of display method, the table's status, including but not limited to time of customer arrival, time of food order, contents of food order (including any special notes by the customer), time of food delivery, time of customer departure, time of table cleaned and available, etc. The server 108 may purge table information based on a specified duration of time passed, as may be defined by the owner of the system.

The server 108 may provide the wait-station device 114 with displayed information regarding customer order status and details, tables occupied and times of customer arrival/departure, beverage status (as defined by the customer on device 104), payment status, table cleanliness, food preparation status, and other various information. The wait-station staff may use the device 114 to notify all staff of table departure, exchange billing related information with the customer and store the information in the database 110, and other tasks. A notification may be sent to the bus-station device 116 upon customer departure to alert bus-station staff as to which tables need cleaning.

The bus-station staff may use the device 116 to notify the hosting staff at device 118 of table availability when an empty table has been cleaned and bussed. Additionally, the server 108 would automatically update all staff devices with these and other status changes.

The hosting area device 118 may be used to notify the wait-station device 114 of new customer arrivals and the respective table occupied.

The administration device 120 would have full access and control to the system. The device 120 would be able to oversee and update any information, among other capabilities.

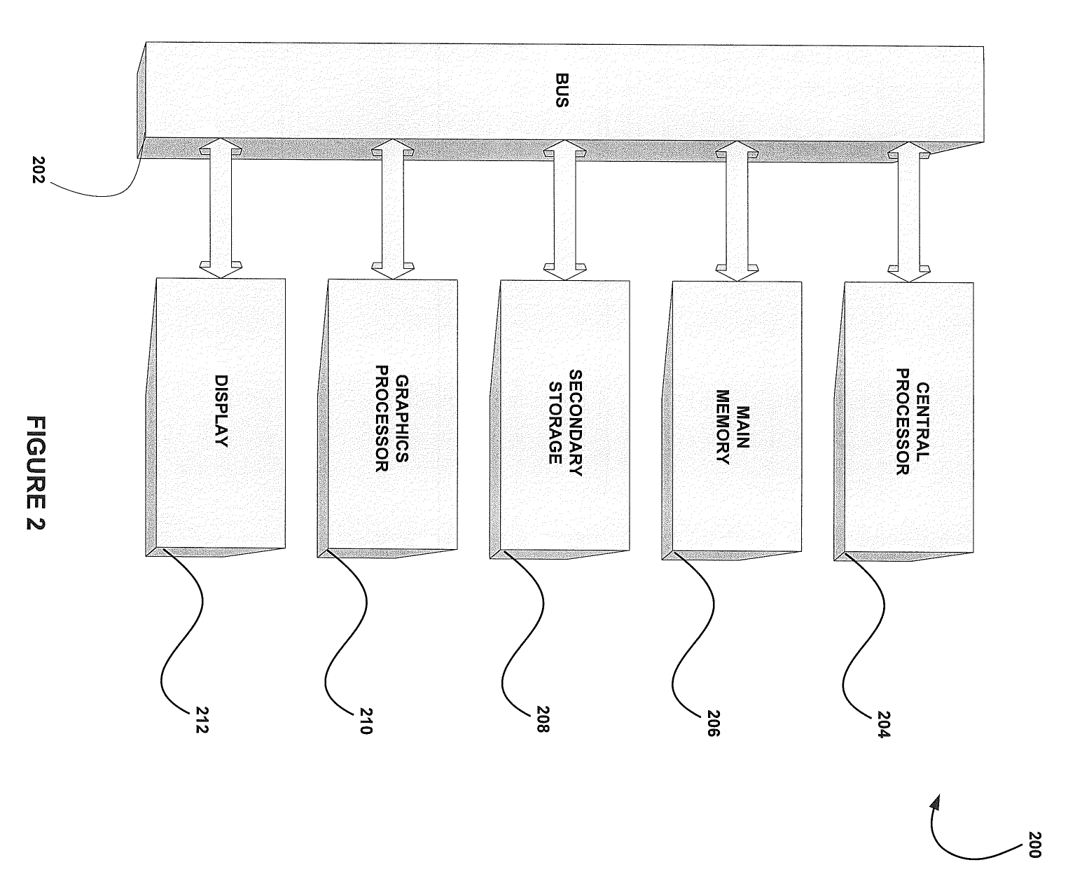

FIG. 2 illustrates an exemplary computer system 200, in which the various embodiments and/or functionality of the previous architecture may be implemented. As an option, the computer system 200 may be implemented in the context of any of the devices of the network architecture 100 of FIG. 1. Of course, the computer system 200 may be implemented in any desired environment.

As shown, a computer system 200 is provided including at least one central processor 204 which is connected to a communication bus 202. The computer system 200 also includes main memory 206 [e.g. random access memory (RAM), etc.]. The computer system 200 also includes a graphics processor 210 and a display 212.

The computer system 200 may also include a secondary storage 208. The secondary storage 212 includes, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the main memory 206 and/or the secondary storage 208. Such computer programs, when executed, enable the computer system 200 to perform various functions. Memory 206, storage 208, and/or any other storage are possible examples of computer-readable media.

The architecture and/or functionality of the previous figures may be implemented in the context of a general computer system, a circuit board system, an application-specific system, and/or any other desired system. For example, the system 200 may take the form of a desktop computer, lap-top computer, and/or any other type of logic. Still yet, the system 200 may take the form of various other devices including, but not limited to, a personal digital assistant (PDA) device, a mobile phone device, etc.

Furthermore, while not shown, the system 200 may be coupled to a network [e.g. a telecommunications network, local area network (LAN), wireless network, wide area network (WAN) such as the Internet, peer-to-peer network, cable network, etc.] for communication purposes.

Additionally, while the system 200 may be present in any combination of the equipment brought forth in the previous architecture, it should also be understood that given the variance of the tasks required of each embodiment, the hardware may be significantly altered to most efficiently achieve the aforementioned tasks.

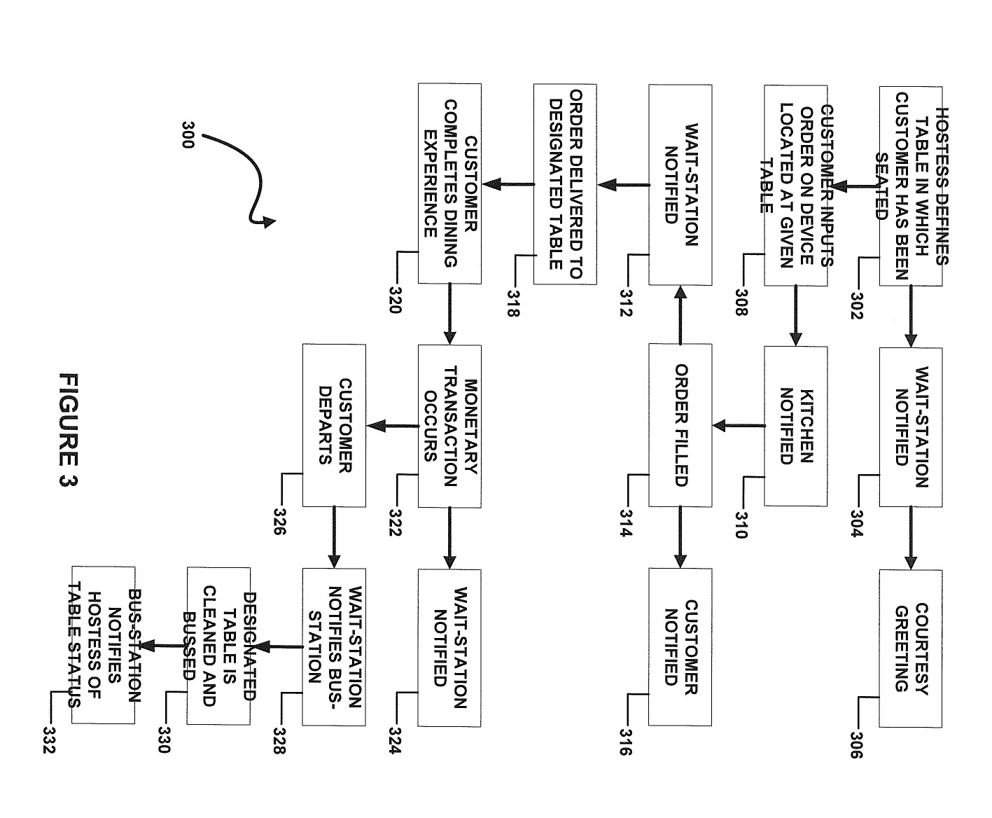

FIG. 3 shows an exemplary method 300, in which the food service process would be carried through in its entirety. In the context of the presentation, this is only a typical customer scenario and is not representative of the full capabilities of the system and should not be perceived as limiting to the design.

The method 300 begins with the arrival of a customer or group of customers. For explanatory simplicity, the method 300 assumes a single customer. The first step of the process consists of the hostess seating the customer and then an event 302 of defining the table in which the customer has been seated. The event 302, once fulfilled via the hosting area device 118, then triggers another event 304, which notifies the wait-station that a customer has arrived and gives the location of the table. As an option, the wait-station computer 114, along with the other staff-controlled computer devices 112, 116, 118, and 120, may allow for real-time status reporting of a table upon selection of it from a menu. This may be implemented in a plurality of methods, including but not limited to touch-screen technology, simple numerical input, voice-activation and speech recognition technology, etc.

As an option, the owner may have the prerogative to implement a courtesy greeting requirement 306 of the wait-staff. This could be done simply by allowing wait-staff input when the task has been performed or may be presented as a simple notice with no requirement for acknowledgement upon completion of the task 306 or lack thereof.

The customer would be able to input a plurality of orders, requests, and notations into the device 102 located at his or her table. The method of input 308 may be achieved in a variety of ways, including but not limited to simple keyboard and/or mouse input, touch-screen technology, voice activation and speech recognition software, etc. Keyboards, monitors, and any other computer device, belonging to customer or staff alike, may be outfitted with plastic or other covering. Menus may be laid out in a variety of presentations, and this process may be made completely customizable to the owner. For exemplary purposes, a menu may have multiple subsections and categories; may only allow selection of currently available purchases, varying by time of day or seasonal; may be numerical and/or require highlighting; may allow an option to make customer notes regarding cooking preference, quantities, selection of pro bono food and drink items, food allergy notations, etc.; may have an option to request a drink refill; and may have an option to call a wait-staff employee and/or manager.

Upon completion of placing the order 308, which may or may not remain an open ticket, the kitchen will receive a notification 310 regarding the event of a new item to be made. The kitchen device 112 may be outfitted with the same or different technology as that of the wait-station device 114. The device 112 and other staff-controlled devices may have a plurality of notification options available, including but not limited to flashing, pop-ups, audio cues, etc. The device 112 may allow for a table to be minimized or selected freely and may be updated in real-time or at any designated time intervals.

Upon completion of filling the order 314, a notification event 312 is sent to the wait-station device 114. As an option, a notification 316, may also be sent to the customer device 102 at any time during the order preparation for a plurality of statuses, including but not limited to awaiting, in progress, completed, delivered, etc. After notification, the wait-staff then delivers the order to the designated table, as illustrated by event 318.

After the event 320 of the customer completing their dining experience, a monetary transaction 322 may then occur. This process 322 may be carried out through various means. As an example, the process 322 may be completed in the traditional way in which a member of the wait-staff delivers a check, which must then be paid for by means of cash, credit, debit, or other, and is signed for as necessary. Alternatively, there may be a payment method available as part of the customer device 102. This may consist of a card reader, cash and change insertion slot, or other monetary transfer process. A touch-screen may be available for signatures, whether as part of the main device 102 or as an extension apparatus (not shown), and may have a pen or other means of signature equipped. As an option, the customer device 102 may be outfitted with unique identifiers for returning visitors, such as fingerprints, facial recognition, voice recognition, a code—username/password, personal identification number (PIN), etc.,—or other identifiers that would be linked to a payment account, such as a credit card or other payment methods. This information may be stored on the database 110. At the discretion of the owner, extensive security encryption and protocols may or may not be implemented.

When the monetary transaction 322 occurs, regardless of the method, a notification 324 may be sent to the wait-station device 114. In the event of the traditional payment method outlined previously, the notification may first be sent as a request for a monetary transaction to occur, and not as a completion, though this is optional and is not limiting to the design.

After the monetary transaction 322 occurs, the customer may then depart from the facility. This action 326 may be perceived visually; may be detected via weight, heat, or motion sensors; or as an option, it may be available to the customer as a notification to send for when he or she departs. The aforementioned action 326 should be understood to be illustrative in purpose and not as a limiting feature of the design—other methods may be implemented to fulfill the action 326. Upon departure, the wait-station may notify the bus-station device 116, or in the event of higher technology means of detection of action 326, the notification 328 may be fully automated.

A bus-station employee may then proceed to the flagged table to clean and bus said table. After this action 330 is completed, the employee then sends a notification 332 to the hosting area device 118 to inform that the table is available for a new customer. This notification may be sent via the bus-station device 116 or, as an option, the customer device 102 may have such staff-related commands available. Access to such commands may be protected through a plurality of means, including but not limited to a keycard, a bar code, an alphanumeric code, a username/password, or any number of other staff-identifying features.

As an option, the administrative computer device 120 may be capable of establishing an open communication (not shown) to the customer device 102. This communication link may be integrated via text, voice, video, or any combination of these methods or other methods.

Stored order and customer information may be purged after a decided duration or retained for a certain duration or indefinitely, based upon the owner's preference and customization of the system.

As an option, the staff may all have unique accounts through which actions may be logged. The administrative computer device 120 may be capable of overseeing and changing any process, menu item, account (staff and/or customer), data, notifications, etc.

As an added feature, a phone device (not shown) may be hooked into the system for pre-placement of orders, allowing a customer to call ahead their order. The application may work by implementing voice-recognition software, using touch-pad numerical definitions, or other means of allowing an order to be accurately recorded by a computer device (not shown) and incorporated into the network 106. As an option, the phone device may also be operated by an individual instead of, or in addition to the automated process of the computer device. In such an event, the customer may have the option to request to speak to an individual. This request may be done vocally or by numeric input.

As an alternative to or in addition to a phone device to achieve pre-ordering by the customer, the server may be connected to the internet, allowing communications into and outside of the restaurant facility. The restaurant may choose to host a website on its system as an interface for the customer. The website may or may not include menus, coupons and specials, a list of employees currently on-duty, what tables are available and what tables are occupied, estimated wait-time to be seated, average time taken between an order being received by the customer and that order being delivered to the customer (the average may be taken over any given time, according to the owner's preference), a list of most frequently ordered menu items over any given set of time or times, etc. The website may allow for a customer to create or log into their account from any computer or advanced cellular device capable of accessing the internet. The customer's account may be linked to identification information, a payment method, and optionally a history of visits, orders, spending, etc. The customer may be able to browse the website, input orders, reserve a specific table and/or waiter or waitress, among other possible actions. Additionally, the restaurant staff may be capable of confirming that any and all of this information has been received. The staff may also be capable of providing an estimate on the time remaining until the order is completed. Furthermore, the staff may have the option of providing a time allotment before the order and reservation expire if the customer fails to be present by the given time. In such an event, the staff may be capable of detailing an entry into the customer's account history, allowing the staff to track and restrict pre-order privileges from customers if a certain threshold is reached. This threshold and the duration of the penalty may be customizable to the owner.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for integrating a computer network in a restaurant, comprising:
receiving user-defined information from a customer device; and
displaying the user-defined information on staff computers.
